(19) United States
(12) Patent Application Publication
(10) Pub. No.: US 2021/0019153 A1
(43) Pub. Date: Jan. 21, 2021

(54) BIOS SETTING AUTOMATIC SWITCHING METHOD, BIOS SETTING AUTOMATIC SWITCHING DEVICE, AND BIOS SETTING AUTOMATIC SWITCHING PROGRAM RECORDING MEDIUM

(71) Applicant: NEC Platforms, Ltd., Kawasaki-shi, Kanagawa (JP)

(72) Inventor: Takeshi SASAKI, Kanagawa (JP)

(73) Assignee: NEC Platforms, Ltd., Kawasaki-shi, Kanagawa (JP)

(21) Appl. No.: 16/955,912

(22) PCT Filed: Oct. 12, 2018
(86) PCT No.: PCT/JP2018/038027

§ 371 Date: Jun. 19, 2020

(30) Foreign Application Priority Data
Dec. 20, 2017 (JP) 2017-243433

(51) Int. Cl. G06F 9/4401

(52) U.S. Cl. CPC G06F 9/4401

(57) ABSTRACT

The purpose of the present invention is to make it possible to perform an operation equivalent to a key operation at a determined input timing, and change a BIOS setting automatically. A keycode conversion/timer control function acquires, from outside, input data constituted of a set of first to N-th (N is an integer of 2 or more) key data and first to N-timing data, and outputs, at a timing predetermined on the basis of n-th (1≤n≤N) timing data, n-th key data corresponding to the n-th timing data. A combination of an input console driver and a Setup Menu Engine executes setting of the n-th key data.

### TECHNICAL FIELD

This invention relates to a BIOS (Basic Input/Output System) setting automatic switching method, a BIOS setting automatic switching device, and a BIOS setting automatic switching program recording medium.

### BACKGROUND ART

As is well known in the technical field, the BIOS is one piece of firmware and is a program, among programs loaded in a computer, which carries out lowest-level input/output to/from hardware.

BIOS software is installed in a personal computer (PC) and is executed at the same time as turning-on of a power source. The BIOS software performs a main operation of initializing the hardware and calling a bootstrap loader from a storage device. Moreover, the BIOS software provides an abstract layer that allows an interaction between an input/output device, such as a keyboard and a display, and the program. A difference between the hardware of a system is hidden by the BIOS. The program does not directly access to the hardware but uses a service which is provided by the BIOS.

In a case of carrying out a starting operation and a setting change of a Setup Menu during a POST (Power On Self Test), it is necessary to carry out an operation using a Keyboard (which will simply be called “Key Operation” hereinafter). Herein, the POST refers to processing carried out before bootstrap when power sources for a computer, a printer, a router, and the like are turned on. When the power sources are turned on, the POST is controlled by the BIOS and initializations for peripheral devices such as a video and a SCSI (Small Computer System Interface) are shared by programs dedicated therefor.

Therefore, in a case where the setting change of the BIOS is temporarily required in a production test process, the Keyboard or external equipment for carrying out control equivalent thereto is required. In addition, the key operation has a possibility of causing an input mistake.

Various methods for preventing such an input mistake due to the key operation have been proposed.

For example, Patent Literature 1 discloses a “keyboardless control apparatus” which allows a keying operation to be automatically carried out. In Patent Literature 1, a keyboard emulation apparatus accurately and automatically emulates key input processing without troubling a human operator and without changing an environment of a main body of an electronic computer. The keyboard emulation apparatus executes processes 1 to 3 as follows. In the process 1, scan codes supplied from a keyboard device are converted into character strings which are stored in an external storage device as a file. In the process 2, the character strings are successively read out of the character string file stored in the external storage device, are converted into the scan codes with reference to a bidirectional conversion table between the scan codes and the character strings, and are outputted to an output device. In the process 3, the output device converts a scan code signal produced in the process 2 according to a scan code signal standard of the electronic computer using the keyboard to produce a converted signal.

In addition, Patent Literature 2 discloses an “automatic transaction device” that simplifies BIOS setting. In the automatic transaction device disclosed in Patent Literature 2, BIOS setting information is stored in a storage unit. The BIOS setting information is information required for setting the BIOS regarding respective hardware configurations customized by requests from users (financial institutions).

Patent Literature 3 discloses a “BIOS update apparatus” configured to automatically recover from system stop, to change BIOS settings, and to execute OS (Operating System) installation even when the OS installation fails to cause system stop, due to improper BIOS settings. The BIOS update apparatus disclosed in Patent Literature 3 comprises an OS selection unit, an update control unit, a BIOS setting list storage unit, an OS installation unit, a first storage unit, a second storage unit, and a timing unit. The update control unit stores first BIOS setting information in the first storage unit. Under an instruction from the update control unit, the timing unit measures a time interval on the basis of a time-out value included in the first BIOS setting information. As the timing unit, for example, a watchdog timer (WDT) or the like may be used. The update control unit restarts the BIOS update apparatus when the timing unit measures a time up to an end of any desired time interval.

### CITATION LIST

### Patent Literature

PTL 1: JP H02-089114 A

PTL 2: JP 2016-085707 A

PTL 3: JP 2016-114974 A

### SUMMARY INVENTION

### Technical Problem

However, the above-mentioned Patent Literatures 1 to 3 have problems as follows.

In Patent Literature 1, an external target emulation device is required. In addition, Patent Literature 1 is effective exclusively for the electronic computer using the keyboard. In other words, Patent Literature 1 is only effective for a control interface depending on a keyboard controller.

In Patent Literature 2, it is necessary to preliminarily prepare data regarding BIOS setting values.

Patent Literature 3 merely discloses a timer function for forcedly restarting when the OS installation fails.

It is an object of this invention to provide a BIOS setting automatic switching method, a BIOS setting automatic switching device, and a BIOS setting automatic switching program recording medium, which are capable of resolving the above-mentioned problems.

### Solution to Problem

As an aspect of the present invention, a BIOS setting automatic switching method is a method of automatically switching settings of a BIOS (Basic Input/Output System) in an information processing apparatus, and comprises acquiring, from outside, input data which comprises a set of first through N-th (N is an integer which is not less than two) key data and first through N-th timing data; producing, at a timing predetermined based on n-th (1≤n≤N) timing data, n-th key data corresponding to the n-th timing data; and executing a setting of the n-th key data.

As another aspect of the present invention, a BIOS setting automatic switching device is a device for automatically switching settings of a BIOS (Basic Input/Output System) in an information processing apparatus, and comprises a key code conversion/timer control means configured to acquire, from outside, input data which comprises a set of first through N-th (N is an integer which is not less than two) key data and first through N-th timing data and to produce, at a timing predetermined based on n-th (1≤n≤N) timing data, n-th key data corresponding the n-th timing data; and an executing means configured to execute a setting of the n-th key data.

As another aspect of the present invention, a BIOS setting automatic switching program recording medium is a recording medium for recording a BIOS setting automatic switching program which causes a computer to automatically switch settings of a BIOS (Basic Input/Output System), and causes the computer to execute the steps of acquiring, from outside, input data which comprises a set of first through N-th (N is an integer which is not less than two) key data and first through N-th timing data; producing, at a timing predetermined based on n-th (1≤n≤N) timing data, n-th key data corresponding to the n-th timing data; and executing a setting of the n-th key data.

### Advantageous Effect of Invention

According to this invention, it is possible to carry out processing equivalent to key operations at determined input timings and to automatically change the BIOS settings.

### BRIEF DESCRIPTION OF DRAWINGS

FIG. 1 is a view for illustrating a configuration of a BIOS setting switching device to which a BIOS setting switching method of related art is applicable.

FIG. 2 is a view for illustrating a configuration of a BIOS setting automatic switching device to which a BIOS setting automatic switching method according to a first example embodiment of the present invention is applicable.

FIG. 3 is a view for illustrating an example of input data for use in the BIOS setting automatic switching device illustrated in FIG. 2.

FIG. 4 is a flow chart for explaining an operation of the BIOS setting automatic switching method according to this example embodiment, in the BIOS setting automatic switching device illustrated in FIG. 2.

FIG. 5 is a view for illustrating a configuration of a BIOS setting automatic switching device to which a BIOS setting automatic switching method according to a second example embodiment of the present invention is applicable.

FIG. 6 is a view for illustrating a configuration of a BIOS setting automatic switching device to which a BIOS setting automatic switching method according to a third example embodiment of the present invention is applicable.

### DESCRIPTION OF EMBODIMENTS

### Related Art

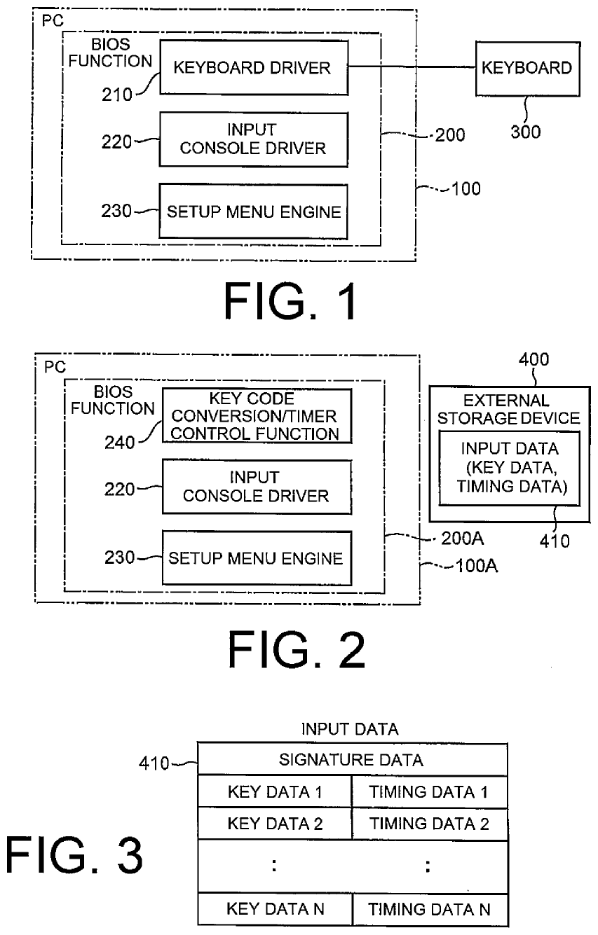

In order to facilitate an understanding of the present invention, at first referring to FIG. 1, description will be made of a BIOS setting switching device to which a BIOS setting switching method of related art is applicable.

The BIOS setting switching device comprises a personal computer (which may simply be mentioned also as “PC” hereinafter) 100 and a Keyboard 300.

The personal computer 100 has a BIOS function 200 of the related art. The BIOS function 200 is also called a BIOS circuitry. The BIOS function 200 comprises a keyboard driver 210, an input console driver 220, and a Setup Menu Engine 230. The keyboard driver 210 receives an input from the external Keyboard 300. The input console driver 220 receives key codes from the keyboard driver 210. The Setup Menu Engine 230 is controlled by the input console driver 220.

As mentioned above, the key operation using the Keyboard 300 has a possibility of causing an input mistake.

### EXAMPLE EMBODIMENTS

Now, example embodiments of the present invention will be described in detail with reference to the drawings.

### First Example Embodiment

Referring to FIG. 2, description will proceed to a BIOS setting automatic switching device to which a BIOS setting automatic switching method according to a first example embodiment of the present invention is applicable.

The BIOS setting automatic switching device comprises a personal computer (PC) 100A and an external storage device 400.

The illustrated personal computer 100A is similar in structure and operation to the personal computer 100 illustrated in FIG. 1 except that the BIOS function (BIOS circuitry) is modified in the manner which will later be described. The BIOS function (BIOS circuitry) is therefore depicted by the reference numeral 200A. In addition, in the illustrated BIOS setting automatic switching device, the external storage device 400 is used in lieu of the Keyboard 300.

The same reference numerals are assigned to parts similar in function to those illustrated in FIG. 1, and description thereof will be omitted in order to simplify the description.

In the personal computer 100A according to the first example embodiment of the present invention, the BIOS function 200A receives input data 410 from the external storage device 400 instead of the external Keyboard 300, as shown in FIG. 2. In addition, the personal computer 100A is newly provided with, instead of the keyboard driver 210, a key code conversion/timer control function 240 for delivering key codes to the input console driver 220. The key code conversion/timer control function 240 is also called a key code conversion/timer control circuitry.

By adopting such a configuration, without using the Keyboard 300 or equivalent control equipment for the BIOS settings, by only reading the input data 410 out of the external storage device 400, it is possible to carry out, at determined timings, equivalent processing as if key operations are performed, and to automatically change the BIOS settings.

In other words, in the first example embodiments, as the BIOS function 200A, is provided the key code conversion/timer control function 240 for carrying out Keyboard emulation using a series of input data as the key codes, without actually performing the key operation, by inputting the key codes and the input timings as the input data 410 of the external storage device 400.

Therefore, it is possible to successively deliver a plurality of key codes obtained from the input data 410 of the external storage device 400 at changed timings and to carry out processing equivalent to the key operations by only reading the input data 410 without using the Keyboard 300 or the equivalent control equipment.

For instance, the input data 410 for which the key operations are desired is preliminarily stored in the external storage device 400 such as a USB (Universal Serial Bus) memory. Herein, the input data 410 comprises data of the key codes and timing data of key entry.

Next, in order to facilitate an understanding of the present invention, differences between the above-mentioned Patent Literatures 1 to 3 and the first example embodiment will be described.

First, description will proceed to differences between the Patent Literature 1 and the first example embodiment.

In the Patent Literature 1, the keyboard emulation device is required on the outside. In comparison with this, in the first example embodiment, the key code conversion/timer control function 240 is provided in the BIOS function 200A. Accordingly, in the first example embodiment, a control device such as the keyboard emulation device is not required on the outside.

In addition, Patent Literature 1 is effective exclusively for the electronic computer using the keyboard. Accordingly, Patent Literature 1 is only effective for the control interface dependent on the keyboard controller.

In comparison with this, the first example embodiment is not dependent on an external interface for control because the key code conversion/timer control function 240 is provided in the BIOS function 200A. In addition to this, in the first example embodiment, only the input data 410 is acquired from the outside and the BIOS function 200A carries out control based on the input data 410 alone. Therefore, in the first example embodiment, the control is possible even in a case where the personal computer 100A does not have an interface of the keyboard controller.

Next, description will proceed to a difference between the Patent Literature 2 and the first example embodiment.

In the Patent Literature 2, the data regarding the BIOS setting values is preliminarily prepared. In comparison with this, in the first example embodiment, data of key codes for key operations in order to change the BIOS settings is prepared. In the first example embodiment, by preparing key inputs for the key operations as the data of the key codes and successively giving the data of the key codes, the control is carried out, as if the key operations are performed, to carry out the BIOS settings.

Finally, description will proceed to a difference between the Patent Literature 3 and the first example embodiment.

The Patent Literature 3 discloses a timer function for forcedly restarting when the OS installation fails (which will be called a “restarting timer function” hereinafter).

In comparison with this, the first example embodiment provides a timer function based on the input timing data (which will be called an “input timing timer function” hereinafter). Accordingly, the restarting timer function of the Patent Literature 3 and the input timing timer function of the first example embodiment are clearly different from each other.

In detail, the input timing timer function of the first example embodiment is a timer function for switching the input timings for data of the key codes based on the values of the timing data and is not accompanied with the restarting. In the input timing timer function of the first example embodiment, the data of the respective key codes are successively delivered at various timings using a timer, based on the timing data. Therefore, it is possible to perform control like that on carrying out continuous key operations at the various input timings, as if the key operations are carried out in the manner similar to a behavior during the key operations.

FIG. 3 is a view for illustrating an example of the input data 410. As shown in FIG. 3, the input data 410 is data in which signature data for file identification is located at the head and thereafter “key data 1” being data of a key code and “timing data 1” being timing information are stored as one set. It is noted that the “key data 1” is also called first key data whereas the “timing data 1” is also called first timing data.

As described above, in a case where there are a plurality of key data to be executed, data in which first through N-th (N is an integer which is not less than two) key data are consecutively stored in combination with first through N-th timing data, respectively, are used as the input data 410.

It is assumed that the USB memory 400 storing the input data 410 is connected to the personal computer 100A as a target and the personal computer 100A is started. In this case, first, the key code conversion/timer control function 240 checks presence or absence of the input data 410 in the USB memory 400 during a POST. When presence of the input data 410 is detected, the key code conversion/timer control function 240 reads the input data 410 and delivers a key code to the input console driver 220. A timing for delivering the key code is determined based on the timing data in the input data 410. The input console driver 220 carries out, based on the delivered key code, control such as starting of the Setup Menu Engine 230.

As described above, the key code conversion/timer control function 240 acquires, from the outside, the input data 410 which comprises a set of the first through the N-th key data and the first through the N-th timing data, to produce, at a timing predetermined by the n-th (1≤n≤N) timing data, the n-th key data corresponding to the n-th timing data. A combination of the input console driver 220 and the Setup Menu Engine 230 serves as an execution means (execution circuitry) for executing a setting of the n-th key data.

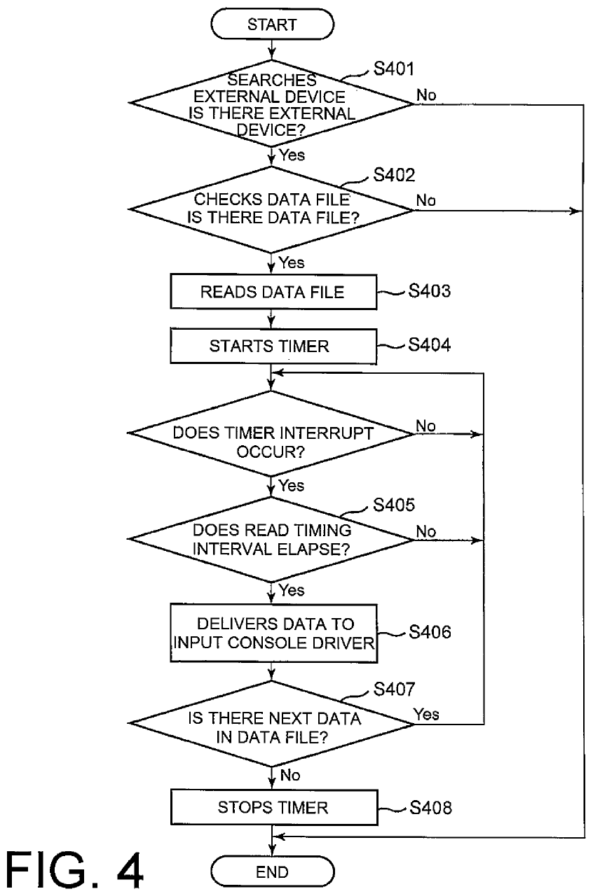

Next, referring to FIG. 4, description will proceed to an operation of the BIOS setting automatic switching method according to this example embodiment.

First, the key code conversion/timer control function 240 searches presence or absence of connection of the external device 400 during the POST (step S401). When there is no external device 400 (No in the step S401), the key code conversion/timer control function 240 finishes the processing with doing nothing.

When there is the external device 400 (Yes in the step S401), the key code conversion/timer control function 240 checks presence or absence of a data file in the external device 400 (step S402). When there is no data file (No in the step S402), the key code conversion/timer control function 240 finishes the processing with doing nothing.

When there is the data file (Yes in the step S402), the key code conversion/timer control function 240 reads the data file (input data 401) from the external device 400 (step S403). Subsequently, the key code conversion/timer control function 240 copies the set of the first through the N-th key data and the first through the N-th timing data from the data file (input data 410) to an internal table (not shown), sets a timer so as to generate an interrupt at regular time intervals and starts the timer (step S404).

After the timer is started, the key code conversion/timer control function 240 checks, by interrupt handler processing which is executed upon occurrence of a regular timer interrupt, whether or not a timing interval (e.g. a first timing interval defined by the first timing data “timing data 1”) obtained from the data file (input data 401) elapses (step S405). When the first timing interval does not elapse (No in the step S405), the key code conversion/timer control function 240 waits for the next timer interrupt. When the first timing interval elapses (Yes in the step S405), the key code conversion/timer control function 240 delivers key data (e.g. first key data “key data 1” corresponding to the first timing data “timing data 1”) to the input console driver 220 (step S406).

The input console driver 220 starts and controls the Setup Menu Engine 230 by dealing with the delivered first key data in the same manner as Keyboard input data (key operation).

After delivering the first key data to the input console driver 220, the key code conversion/timer control function 240 checks the next data (e.g. second key data “key data 2”) in the data file (step S407). When data still exists (Yes in the step S407), the key code conversion/timer control function 240 reads a timing interval (e.g. a second timing interval defined by the second timing data “timing data 2”) of the next data (e.g. the second key data “key data 2”) and, after waiting for time to pass, by the timer interrupt handler processing, until the next timing interval (second timing interval) elapses (Yes in the step S405), delivers the next key data (in this example, the second key data “key data 2”) to the input console driver 220 (the step S406). The above-mentioned processing (steps S407, S405, and S406) is repeated until no data exists in the data file.

When there is no next data in the data file (No in the step S407), the key code conversion/timer control function 240 stops the timer (step S408), and then operation of the key code conversion/timer control function 240 finishes.

Next, description will proceed to effects of the first example embodiment.

A first effect is that it is possible to prevent the setting mistake due to the Keyboard entry when changing of the BIOS settings is carried out in factory production/testing and/or a field and to reliably carry out operation of the same operation for a plurality of personal computers.

A second effect is that it is possible to easily carry out the changing of the BIOS settings for a Keyboardless device.

It is noted that the personal computer 100A may be implemented by a computer using a combination of hardware and software. That is, the personal computer 100A may be implemented as various means by causing the hardware such as a CPU (Central Processing Unit) to operate based on a BIOS setting automatic switching program stored in a program memory (not shown). The BIOS setting automatic switching program is read into the program memory via a wire, wirelessly, or via a recording medium itself and causes the hardware of the personal computer 100A to operate. The recording medium is exemplified by an optical disc, a magnetic disk, a semiconductor memory device, a hard disk and so on.

### Second Example Embodiment

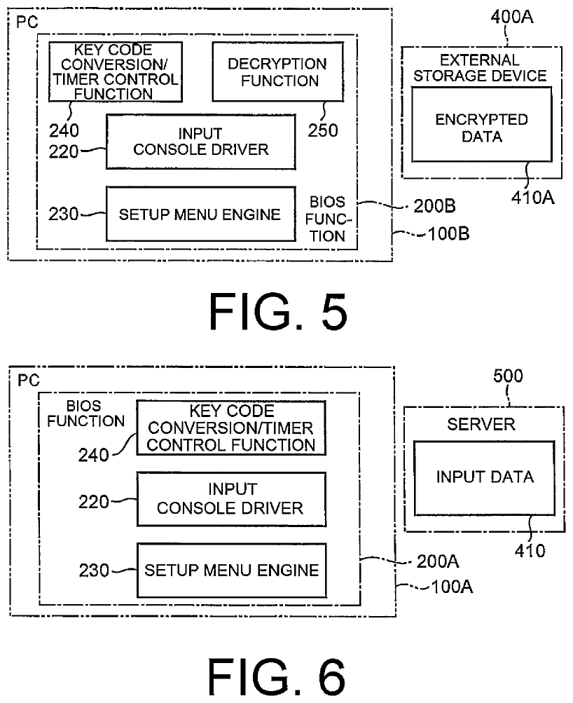

Referring to FIG. 5, description will proceed to a BIOS setting automatic switching device to which a BIOS setting automatic switching method according to a second example embodiment of the present invention is applicable.

The BIOS setting automatic switching device comprises a personal computer (PC) 100B and an external storage device 400A.

The illustrated personal computer 100B is similar in structure and operation to the personal computer 100A illustrated in FIG. 2 except that the BIOS function (BIOS circuitry) is modified in the manner which will later be described. The BIOS function (BIOS circuitry) is therefore depicted by the reference numeral 200B. In addition, the external storage device 400A is different in stored contents from the external storage device 400 illustrated in FIG. 2 as will later be described. The same reference numerals are assigned to parts similar in function to those illustrated in FIG. 2, and description thereof will be omitted in order to simplify the description.

The external storage device 400A stores, in place of the input data 410, encrypted data 410A obtained by encrypting the input data 410 using an encryption key.

On the other hand, the BIOS function 200B is similar in structure and operation to the BIOS function 200A illustrated in FIG. 2 except that a decryption function 250 is further provided. The decryption function 250 is also called a decryption circuitry.

The decryption function 250 decrypts the encrypted data 410A received from the external storage device 400A using a decryption key into the original input data 410. The decryption function 250 supplies the decrypted input data 410 to the key code conversion/timer control function 240.

As described above, in the second example embodiment, a security function (encryption/decryption function) is added to the above-mentioned first example embodiment so that the encrypted data 410A is used as the input data stored in the external storage device 400A.

Next, description will proceed to effects of the second example embodiment. The second example embodiment exhibits, in addition to the first and the second effects of the above-mentioned first example embodiment, a third effect as follows.

The third effect is that security can be improved.

### Third Example Embodiment

Referring to FIG. 6, description will proceed to a BIOS setting automatic switching device to which a BIOS setting automatic switching method according to a third example embodiment of the present invention is applicable.

The illustrated BIOS setting automatic switching device is similar in structure and operation to the BIOS setting automatic switching device illustrated in FIG. 2 except that a server 500 is provided in lieu of the external storage device 400.

The server 500 is connected to the personal computer 100A via a network. The network may be wired or may be wireless.

In the third example embodiment, the input data 410 is put on the server 500 connected to the network. The personal computer 100A acquires the input data 410 from the server 500 via the network to carry out control.

The third example embodiment exhibits similar effects to the first and the second effects of the above-mentioned first example embodiment.

While the invention has been particularly shown and described with reference to example embodiments thereof, the invention is not limited to these embodiments. It will be understood by those of ordinary skill in the art that various changes in form and details may be made therein within the scope of the present invention.

For instance, the keyboard driver 210 is deleted in the above-mentioned example embodiments but may be left without being deleted. In this case, the personal computer may be used also as a general-purpose device which can use the Keyboard 300 as a normal mode of operation. In addition, this invention is not limited to the personal computers and may be applicable to other information processing devices.

### INDUSTRIAL APPLICABILITY

This invention is applicable to a changing operation of the BIOS settings in a testing process of a device production factory in which the changing of the BIOS settings is required, or under an environment where a consoleless device and/or the outside Keyboard cannot be connected.

This application is based upon and claims the benefit of priority from Japanese Patent Application No. 2017-243433, filed on Dec. 20, 2017, the disclosure of which is incorporated herein in its entirety by reference.

### REFERENCE SIGNS LIST

100A, 100B personal computer (PC)
200A, 200B BIOS function (BIOS circuitry)
220 input console driver (execution circuitry)
230 Setup Menu Engine (execution circuitry)
240 key code conversion/timer control function (key code conversion/timer control circuitry)
250 decryption function (decryption circuitry)
400, 400A external storage device (USB memory)
410 input data
410A encrypted data
500 server

What is claimed is:

1. A method of automatically switching settings of a BIOS (Basic Input/Output System) in an information processing apparatus, the BIOS setting automatic switching method comprising:
acquiring, from outside, input data which comprises a set of first through N-th (N is an integer which is not less than two) key data and first through N-th timing data;
producing, at a timing predetermined based on n-th (1≤n≤N) timing data, n-th key data corresponding to the n-th timing data; and
executing a setting of the n-th key data.

2. The BIOS setting automatic switching method as claimed in claim 1, comprising acquiring the input data from an external storage device.

3. The BIOS setting automatic switching method as claimed in claim 1, comprising acquiring the input data from a server via a network.

4. (canceled)

5. A BIOS setting automatic switching device for automatically switching settings of a BIOS (Basic Input/Output System) in an information processing apparatus, the BIOS setting automatic switching device comprising:
a key code conversion/timer control circuitry configured to acquire, from outside, input data which comprises a set of first through N-th (N is an integer which is not less than two) key data and first through N-th timing data and to produce, at a timing predetermined based on n-th (1≤n≤N) timing data, n-th key data corresponding the n-th timing data; and
an executing circuitry configured to execute a setting of the n-th key data.

6. The BIOS setting automatic switching device as claimed in claim 5, wherein the key code conversion/timer control circuitry acquires the input data from an external storage device.

7. The BIOS setting automatic switching device as claimed in claim 5, wherein the key code conversion/timer control circuitry acquires the input data from a server via a network.

8. (canceled)

9. A non-transitory recording medium for recording a BIOS setting automatic switching program which causes a computer to automatically switch settings of a BIOS (Basic Input/Output System), the BIOS setting automatic switching program causing the computer to execute the steps of:
acquiring, from outside, input data which comprises a set of first through N-th (N is an integer which is not less than two) key data and first through N-th timing data;
producing, at a timing predetermined based on n-th (1≤n≤N) timing data, n-th key data corresponding to the n-th timing data; and
executing a setting of the n-th key data.

10. (canceled)
